(19) United States
(12) Patent Application Publication
(10) Pub. No.: US 2022/0411046 A1
(43) Pub. Date: Dec. 29, 2022

(54) VORTEX CONTROL ON ENGINE NACELLE STRAKE AND OTHER VORTEX GENERATORS

(71) Applicant: UNIVERSITY OF WASHINGTON, SEATTLE, WA (US)

(72) Inventors: Giovanni NINO, SEATTLE, WA (US); Lucas J. WEBER, SEATTLE, WA (US); Tobias WITTIG, SEATTLE, WA (US); Robert E. BREIDENTHAL, SEATTLE, WA (US)

(73) Assignee: UNIVERSITY OF WASHINGTON, SEATTLE, WA (US)

(21) Appl. No.: 17/756,225

(22) PCT Filed: Nov. 19, 2020
(86) PCT No.: PCT/US2020/061338

§ 371 Date: May 19, 2022

Related U.S. Application Data
(60) Provisional application No. 62/938,698, filed on Nov. 21, 2019.

(51) Int. Cl. B64C 23/06; B64D 29/02; B63B 1/34

(52) U.S. Cl. CPC B64C 23/06; B64D 29/02; B63B 1/34; B64C 2230/04; B64C 2230/12

(57) ABSTRACT

Apparatuses and methods for controlling fluid flow over surfaces, e.g. wings, are disclosed. A system can include a surface influenced by a fluid flow moving across the surface, a vortex generator disposed proximate to the surface, the vortex generator for altering a vortex pattern within the fluid flow moving across the surface, and a controller for activating the vortex generator to alter the vortex pattern within the fluid flow moving across the surface. The vortex generator can comprise one or more fluid injectors each for injecting a fluid jet into the fluid flow driven by air pressure. The fluid injectors can be disposed along a leading edge of a strake where the strake is disposed on an engine nacelle and the surface comprises an aircraft wing surface. Activation can occur under open or closed loop control with sensors.

### CROSS-REFERENCE TO RELATED APPLICATION

This application claims the benefit under 35 U.S.C. § 119(e) of the following U.S. provisional patent application, which is incorporated by reference herein: U.S. Provisional Patent Application No. 62/938,698, filed Nov. 21, 2019, and entitled “VORTEX CONTROL ON ENGINE NACELLE STRAKE AND OTHER VORTEX GENERATORS,” by Nino et al. (Attorney Docket No. 48593.01US1).

### BACKGROUND OF THE INVENTION

### Field of the Invention

The invention is related to methods and apparatuses for controlling fluid flow over surfaces, e.g. air over airfoils, Particularly, the invention is related to methods and apparatuses for controlling vortex generators in order to improve effects of the fluid flow on the surface (e.g. lift and drag) by altering vortex patterns within fluid flow moving across a surface.

### 2. DESCRIPTION OF THE RELATED ART

Passive vortex generators have been used to optimize air flow in a variety of applications. From sports cars, wind turbines and heat exchangers, to the most commonly known application on wings and other surfaces of aircraft, vortex generators are devices with a wide range of uses. With their simple mechanical design, passive vortex generators are a robust, reliable and inexpensive way of preventing flow separation, to increase lift and decrease drag and/or to improve mixing. This design however also has drawbacks. Being a passive device, such vortex generators cannot be moved or retracted during operation. Thus, it is not possible for such devices to react to different external conditions, like another phase of flight, a different flow velocity or angle of attack.

Vortex generators have been used in a passive manner to prevent or delay flow separation on airfoils and even recent developments of the aerospace industry rely on artificially created vortices to increase lift and decrease drag. FIG. 1A illustrates prior art “passive” vortex generators on a wing and FIG. 1B illustrates prior art vortex interaction with high-lift surfaces. Some other work involving vortex generators for aircraft has been done. However, these systems involve moving parts, reducing their reliability and increasing weight. In addition, an active vortex generator system has been applied to sensor applications.

One example of passive vortex generator applications is the placement of strakes on an engine nacelle. Especially in a high-lift configuration and at high angles of attack, the wing area affected by the wake of the engine nacelle and the complex flow field caused by the slat cutout is prone to separation and an associated loss of lift, FIG. 2A illustrates an example prior art vortex trail from an engine nacelle over a wing. To reduce this effect, a strake on the nacelle can be used to generate a new strong vortex that prevents the complex flow structures induced by the engine nacelle and its interaction with the leading-edge high-lift devices from causing premature flow separation. FIG. 2B illustrates a prior art computational fluid dynamics (CFD) analysis of unmodified airflow across an engine nacelle and wing and FIG. 2C illustrates the prior art airflow with an engine nacelle strake added.

Since the nacelle strake is a passive device, it has to be very carefully designed in order to fulfill the requirements regarding the prevention of flow separation at high angles of attack, as well as a preferably low drag penalty caused by the strake itself at low angles of attack, e.g. under a cruise condition. In this case, flow over the wing surface is not prone to influence by the engine mount structure or the nacelle, Therefore, the design of a passive nacelle strake must be a compromise between the optimization for both conditions.

In view of the foregoing, there is a need in the art for methods and apparatuses to control fluid flow over surfaces, such as airflow over wing surface. There is a need for such methods and apparatuses to actively control the generation of vortices to aid reducing skin friction by re-laminarizing the turbulent boundary layer. There is also a need for such methods and apparatuses to operate with fewer moving parts. There is further a need for such systems and methods to be both versatile and cost effective. There is still further a need for such fluid flow control techniques to be applied with water for water vehicles. These and other needs are met by the present invention as described in detail hereafter.

### SUMMARY OF THE INVENTION

Apparatuses and methods for controlling fluid flow over surfaces, e.g. wings, are disclosed. A system can include a surface influenced by a fluid flow moving across the surface, a vortex generator disposed proximate to the surface, the vortex generator for altering a vortex pattern within the fluid flow moving across the surface, and a controller for activating the vortex generator to alter the vortex pattern within the fluid flow moving across the surface. The vortex generator can comprise one or more fluid injectors each for injecting a fluid jet into the fluid flow driven by gas pressure. The fluid injectors can be disposed along a leading edge of a strake where the strake is disposed on an engine nacelle and the surface comprises an aircraft wing surface. Activation can occur under open or closed loop control with sensors.

One exemplary embodiment of the invention comprises a system for controlling fluid flow including a surface for being influenced by a fluid flow moving across the surface, a vortex generator comprising a strake disposed forward in the fluid flow from the surface, the vortex generator for altering a vortex pattern within the fluid flow moving across the surface by exerting a force at a leading edge of the strake when activated, and a controller for activating the vortex generator to alter the vortex pattern within the fluid flow moving across the surface. Typically, the system can alter the vortex pattern by repositioning the fluid flow and the vortex to re-laminarize a turbulent boundary layer passing the surface. Some embodiments of the invention can further comprise a sensor for sensing an undesirable vortex pattern and triggering the controller to activate the vortex generator. In some embodiments of the invention, the strake can be disposed on an engine nacelle and the surface comprises a wing surface. The surface can be on an aerial or land vehicle where the fluid flow comprises air or on an underwater vehicle where the fluid flow comprises water.

In some embodiments of the invention, the force can be generated by a plasma actuator generating a plasma within the fluid flow. The plasma actuator can comprise a dielectric barrier discharge (DBD) plasma actuator or a corona discharge plasma actuator.

In some embodiments of the invention the vortex generator can comprise one or more actuated vanes disposed along the leading edge of the strake each positionable at a varied pitch against the fluid flow to exert the force. In other embodiments of the invention, the vortex generator can comprise one or more fluid injectors disposed along the leading edge of the strake each for injecting a fluid jet into the fluid flow to exert the force.

For embodiments of the invention where the vortex generator comprises one or more fluid injectors, each fluid jet of the one or more fluid injectors can be driven by gas pressure, e.g. air. At least one fluid jet of the one or more fluid injectors can be injected from a cylindrical port or a rectangular port. The one or more fluid injectors can each be operated independently by the controller to improve different undesirable vortex patterns within the fluid flow.

In some embodiments of the invention, one or more sensors can be used for sensing the vortex pattern within the fluid flow as undesirable and triggering the controller to activate the vortex generator to improve the vortex pattern within the fluid flow, wherein the surface comprises at least a portion of a wing or fuselage surface and the strake is disposed thereon. The one or more sensors can comprise one or more heat flux sensors embedded in the wing or fuselage surface for sensing the vortex pattern as undesirable within the fluid flow. The one or more sensors can comprise one or more pressure sensors embedded in the wing or fuselage surface for sensing the vortex pattern as undesirable within the fluid flow.

Another exemplary embodiment comprises a method for controlling fluid flow including creating a surface for being influenced by a fluid flow moving across the surface, disposing a vortex generator comprising a strake forward in the fluid flow from the surface, the vortex generator for altering a vortex pattern within the fluid flow moving across the surface by exerting a force at a leading edge of the strake when activated, and activating the vortex generator with a controller to alter the vortex pattern within the fluid flow moving across the surface. The method can be further modified consistent with any of the apparatus or system embodiments described herein.

Yet another exemplary embodiment comprises apparatus for controlling fluid flow having a surface for being influenced by a fluid flow moving across the surface, a vortex generator comprising a strake disposed forward from the surface in the fluid flow and comprising one or more fluid injectors disposed on a leading edge of the strake each for injecting a fluid jet into the fluid flow driven by air pressure, the vortex generator for altering a vortex pattern within the fluid flow moving across the surface by exerting a force at the leading edge of the strake and a controller for activating the vortex generator to alter the vortex pattern within the fluid flow moving across the surface. The apparatus can be further modified consistent with any of the method or system embodiments described herein.

### BRIEF DESCRIPTION OF THE DRAWINGS

FIG. 1A illustrates prior art “passive” vortex generators on a wing;

FIG. 1B illustrates prior art vortex interaction with high-lift surfaces;

FIG. 2A illustrates prior art vortex trail from an engine nacelle over a wing;

FIG. 2B illustrates a computational fluid dynamics (CFD) analysis of unmodified airflow across an engine nacelle and wing;

FIG. 2C illustrates a computational fluid dynamics (CFD) analysis of airflow with an engine nacelle stroke added;

FIG. 3A is a schematic side view diagram of an exemplary system where a vortex generator is disposed apart from the surface of interest affected by the fluid flow;

FIG. 3B is a schematic side view diagram of an exemplary system where a vortex generator is disposed on a forward portion the surface of interest affected by the fluid flow;

FIG. 3C shows typical delta, rectangle, cropped-delta, and trapezium geometries for vane-type vortex generators;

FIG. 4A is a schematic diagram of an exemplary vortex generator comprising a dielectric barrier discharge plasma actuator located on its leading edge;

FIG. 4B is a schematic diagram of an exemplary vortex generator comprising a corona discharge plasma actuator located on its leading edge;

FIG. 5 illustrates a vortex generator comprising a functional single plasma actuator;

FIG. 6 is a schematic of a vortex generator comprising multiple electrical plasma actuators;

FIG. 7 illustrates a vortex generator comprising multiple air jet injectors on its leading edge;

FIG. 8 illustrates a vortex generator comprising multiple positionable vanes on its leading edge;

FIGS. 9A and 9B illustrate a vortex generator comprising multiple air jet injectors on its leading edge each having a circular outlet;

FIGS. 10A and 10B illustrates a vortex generator comprising multiple air jet injectors on its leading edge each having a slotted outlet;

FIG. 11 is a schematic diagram of a system employing a plurality of vortex generators each comprising multiple air jet injectors driven by an air supply under control by a sensor;

FIGS. 12A to 12C are example fluid flow velocity measurement plots downstream from a vortex generator with injection ON at 15 psi, round holes (solid lines, OFF dash lines) and round holes;

FIG. 13 shows an example position of vortex core from varying injection pressure at position 1 relative to the baseline case without injection (dash lines);

FIGS. 14A to 14C are example fluid flow velocity measurement plots downstream from a vortex generator with injection ON at 10 psi (solid lines, OFF dash lines) and slots;

FIG. 15 illustrates vortex flow control over an aircraft engine nacelle where the vortex is moved from position A to position B;

FIG. 16 illustrates an example sensing layout for a vortex control system where vortex B represents a modified vortex A that has been controlled/modified by an actuator mounted on a vortex generator and the vortex generators are in disposed in parallel;

FIG. 17 illustrates an example sensing layout for a vortex control system where the vortex has been controlled modified by an actuator mounted on a vortex generator and the vortex generators are disposed in series;

FIG. 18A illustrates flow separation for an example conventional wing above the critical Mach number without vortex control:

FIG. 18B illustrates flow separation for an example conventional wing above the critical Mach number with vortex control;

FIG. 19A illustrates flow over a hot surface with vortex generators without injection; and

FIG. 19B illustrates flow over a hot surface with vortex generators with injection.

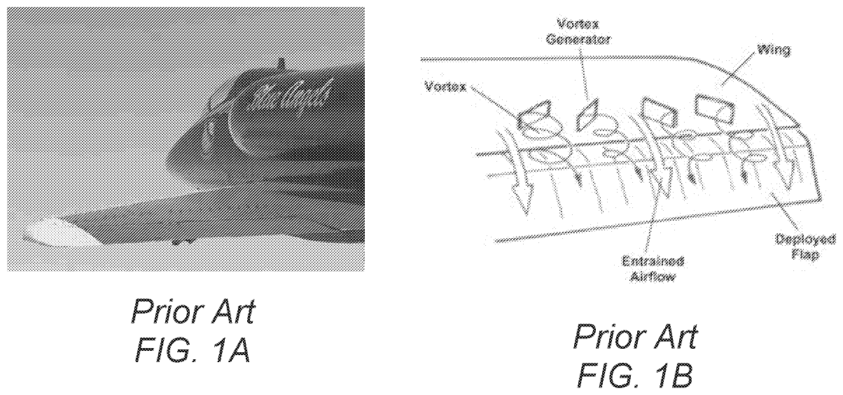

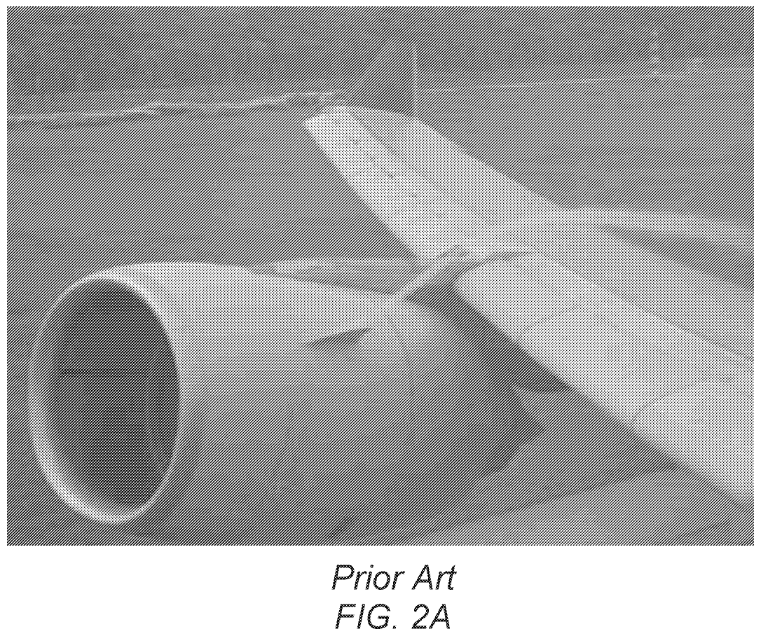

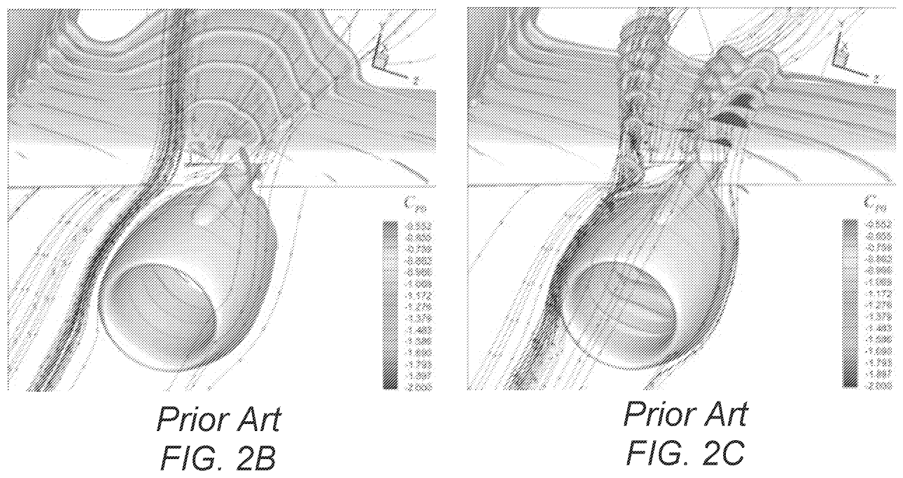

### DETAILED DESCRIPTION

In the following description including the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

### 1.0 Overview

If the generation of the strake vortex could be actively controlled in a way that enables precise positioning of the vortex, so that the vortex downwash, which transports highly energetic fluid close to the wing's surface, can be positioned exactly where it is needed, a vortex generator can be implemented in a less intrusive manner reducing its size. This can reduce parasitic drag that is induced by the strake.

An optimized and actively controllable vortex position can achieve higher lift, not only at maximum angle of attack, but also over a range of angles of attack. Accordingly, higher wing effectiveness can allow for a smaller wing, reducing aircraft weight while reducing power consumption or improving fuel efficiency and thereby lowering CO₂ emissions. In addition to an application on engine nacelle strakes, active vortex control in accordance with the invention can also be implemented in a system to aid reducing skin friction by re-laminarizing the turbulent boundary layer. This can be achieved in applications where the vortex can be sustained stationary close to a surface. Total aircraft drag can be reduced, potentially by as much as a factor of two, which can lead to the aforementioned reductions in fuel consumption, CO₂ emissions, electrical power consumption on electrical aircraft, as well as reduced aircraft noise.

An exemplary vortex generator (VG) employing a plurality of gas nozzles mounted on a flat plate (i.e. a wall) or surface can demonstrate that the vortex trajectory can be moved to a wide range of positions by changing the activated nozzle location and thrust. Counter-intuitively, it can be demonstrated that the vortex can be moved closer to the flat plate by a gas nozzle thrusting away from the surface. Similarly, the vortex strength can be increased or decreased by the use of gas nozzles or other types of actuators. Therefore, the vortices can be controlled in position (localization) and intensity over a desired surface, device, or vehicle.

A way to actively influence the position of a vortex, produced by a vortex generator, for example a trapezoidal one, is described hereafter. Wind tunnel data can show that the trajectory of a vortex downstream of the vortex generator can be significantly altered by generating a force along the swept leading edge of the vortex generator. This force can be generated by a plasma jet, air injection through a nozzle, or a positionable element on the vortex generator that deflects the oncoming fluid flow.

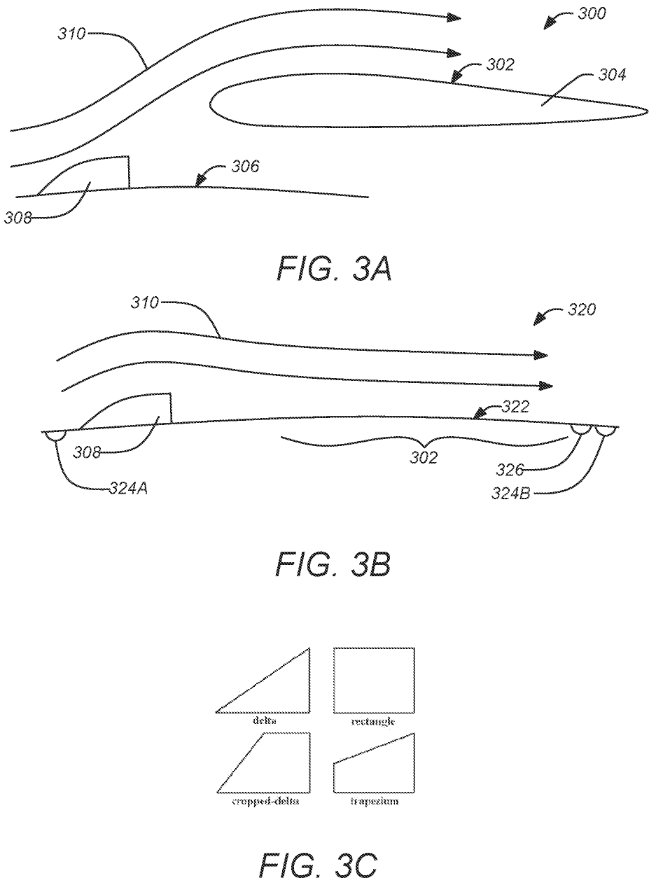

FIG. 3A is a schematic side view diagram of an exemplary system 300 where a vortex generator 308 is disposed apart from the surface 302 of interest affected by the fluid flow 310. For example, this layout could represent a vortex generator 308 disposed on an engine nacelle 306 below a wing 304. Accordingly, the upper surface of the wing 304 represents the surface 302 affected by the fluid flow 310 which passes the vortex generator 308 on the nacelle 306 to then pass over the wing 304.

FIG. 3B is a schematic side view diagram of another exemplary system 320 where a vortex generator 308 is disposed on a forward portion the surface 302 of interest affected by the fluid flow 310, In this case, the portion surface 302 affected by the fluid flow 310 may be either a larger wing or fuselage surface 322 with the vortex generator 308 disposed forward in the fluid flow 310 from the surface 302 portion of interest. One or more pressure sensors 324A, 324B may also be employed in this system 320 with one set of pressure sensors 324A disposed in the surface 322 upstream from the vortex generator 308 in the fluid flow 310 and another set of pressure sensors 324B disposed downstream in the surface 322 from the portion of the surface 302 of interest. One or more heat flux sensors 326 can also be employed disposed downstream in the surface 322 from the portion of the surface 302 of interest.

Unless an alternate context is provided, “surface” employed in the present application indicates the surface area of interest downstream from and affected by the fluid flow under influence of the vortex generator when activated. Typically, this surface area of interest can be on a separate element from the location of the vortex generator or on a portion of the same element that also supports the vortex generator.

It should also be noted that, although the primary embodiments of the invention described herein refer to air flow and aircraft, the described principles and embodiments can be directly applied to any fluid flow type that can generate vortices affecting a surface it passes. For example, embodiments of the invention can also be applied to incompressible fluid flows such as water as will be understood by those skilled in the art.

### 1.1 Passive Vortex Generators

One of the most common applications of passive flow control is the usage of vortex generators. Small-aspect-ratio airfoils or tabs attached to a surface over which flow is susceptible to separation produce vortices to move high-energy flow from the outer region of the boundary layer to the wall. The addition of momentum to this area enables the flow to overcome a pressure gradient by mixing with and replacing near-wall flow.

For many years, vortex generators have been used in an extensive variety of applications and are still being taken advantage of, even in the most recent developments, not only in the aerospace sector. Probably the most obvious application is the placement of vortex generators on the upper side of an aircraft's main wing, however they can also be used to increase control surface effectivity, increase pressure recovery over a diffuser or even reduce aerodynamic drag for athletes.

While drag is dramatically reduced by vortex generators when keeping a flow attached that would otherwise be separated, they will increase air resistance at low angles of attack, for example on a wing in cruise flight. When designing an array of vortex generators, multiple parameters have to be taken into consideration to reduce this negative effect as far as possible while still preventing separation under the anticipated flow conditions.

FIG. 3C shows some conventional delta, rectangle, cropped-delta, and trapezium geometries for vane-type vortex generators. To achieve flow attachment over a large area, multiple vortex generators are usually arranged in a manner that produces either co-rotating or counter-rotating vortices. It should be noted that, although the cropped-delta geometry is illustrated in various embodiments of the invention using active vortex control described hereafter, those skilled in the art will appreciate that any of these alternate geometries for vane-type vortex generators or any other known suitable geometry may also be employed. In addition, although the basic shapes of the delta, rectangle, cropped-delta, and trapezium geometries are illustrated having straight edges, these geometries can also be formed having curved edges for some applications as will be understood by those skilled in the art.

Conventional vortex generators with a height h_{VG} (vortex generator height) of about the boundary layer thickness have been used for many years. Later research has shown that low-profile vortex generators with a height between 10% and 50% could improve performance by lowering the produced drag while still keeping the flow attached. The described later designs however have to be placed more closely to the expected separation point, thereby limiting the operating range.

Wind tunnel tests using plasma actuators (dielectric barrier discharge and corona discharge actuators), and nozzle jets (e.g. air injection) can demonstrate that the trajectory of a vortex downstream from a vortex generator can be significantly altered by generating a force along the swept leading edge of the vortex generator. The force can be delivered to the fluid flow from a plasma jet, an ionic wind actuator, a nozzle jet, a suction slot, or a relatively small vortex generator (e.g. small tab, bump, fin, pin, or any other similar mechanical device) as described hereafter. In one embodiment of the invention, a plurality of smaller vortex generator vanes can be disposed on the leading edge of a larger vortex generator. These devices and/or actuators can be placed not only on the vortex generator leading edge but also on its trailing edges, and/or on both sides if needed. In a further embodiment of the invention, one or more actuators can be placed on the sides of the vortex generator (e.g. on one side or both sides) to produce the desired level of control.

### 1.2 Passive Vortex Generators on an Engine Nacelle

Another example application of vortex generators is the placement of strakes on an aircraft engine's nacelle. Especially in a high-lift configuration and at high angles of attack, the wing area affected by the wake of the engine nacelle and pylon, and the complex flow field caused by the slat cutout is prone to separation and its associated loss of lift. The development and introduction of ultrahigh-bypass and geared turbofan engines with growing fan diameters has further intensified the influence of the nacelle on the attainable C_{L,max} (maximum lift coefficient). To reduce this effect, the strake on the nacelle generates a new strong vortex that prevents the flow structures induced by the engine nacelle and its interaction with the leading-edge high-lift devices from causing premature flow separation.

Since the nacelle strake is a purely passive device, it has to be very carefully designed in order to fulfill the requirements regarding the prevention of flow separation at high angles of attack, as well as a preferably low drag penalty caused by the strake itself at low angles of attack, e.g. cruise condition. In this case, flow over the wing's surface is not prone to influence by the engine mount structure or the nacelle. Therefore, the design of a passive nacelle strake can always only be a compromise between the optimization for both conditions.

If the generation of the strake vortex could be actively controlled in a way that would enable the precise positioning of the vortex, so that its downwash, which transports highly energetic fluid close to the wing's surface, could be positioned exactly where it is needed, the vortex generator could be designed in a less intrusive manner, for example by reducing its size, which would reduce drag that is induced by the strake. Especially in cruise flight, a smaller nacelle strake would allow for lower fuel consumption, while still maintaining functionality under high-angle-of-attack conditions. By optimizing the vortex position through active control, lift could be increased over a range of angles of attack, permitting a smaller wing, reducing aircraft weight and lowering CO₂ emissions.

### 2.0 Exemplary Plasma Actuator Vortex Generator

Some embodiments of the invention employ vortex manipulation through plasma actuation. An experimental setup can be used to locate the vortex position and evaluate the influence on the vortex from a plasma actuator by means of an array of static pressure measurements downstream of the vortex generator.

The results of the pressure measurements can show that the vortex can be reliably located with this method. Further experiments can be conducted by placing a dielectric harder discharge (DBD) actuator downstream of the vortex generator. A vortex generator can be mounted on one side of a plate with a plasma actuator positioned between the vortex generator and an array of static pressure holes on the opposite side of the plate. The induced flow of the actuator can be in the same direction as the vortex rotation at the surface. The pressure measurements can show very small increases of static pressure above the position of the vortex, when the plasma actuator is activated, indicating a possible shift of the vortex position, however, no pressure decrease is detected in the area below the vortex that would have been expected, if a change of the vortex position occurs. Accordingly no certain conclusion regarding the influence of the plasma actuation can be drawn. The plasma actuator can also be placed directly on the vortex generator, instead of the surface downstream of the vortex generator, inducing flow in the development phase of the vortex, where the effect should be greatest. A displacement of the vortex away from the surface caused by a reduction of the lift coefficient of the vortex generator when the plasma actuator is active across the vortex generator is contemplated.

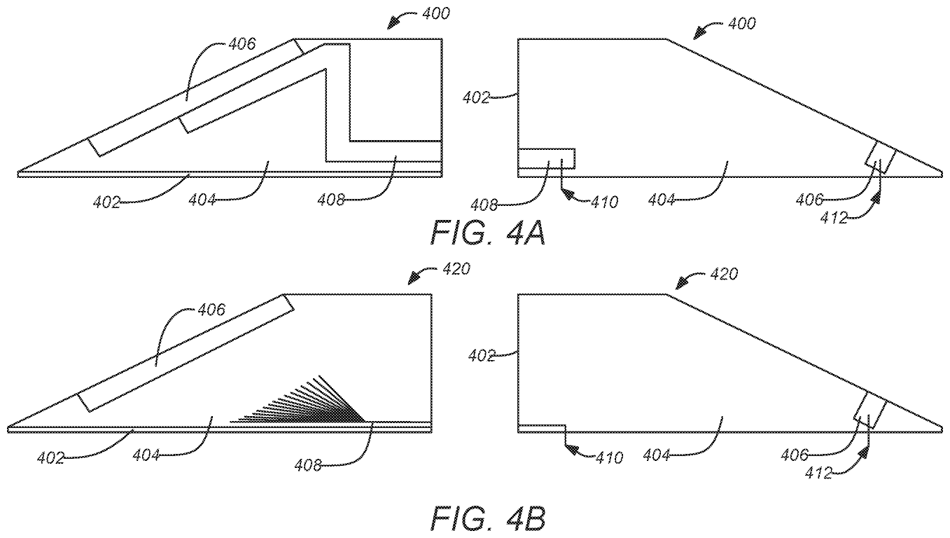

FIG. 4A is a schematic diagram of an exemplary vortex generator 400 comprising a dielectric barrier discharge plasma actuator. Such a plasma actuator can deliver a maximum velocity of about 1.5 m/s at a distance of approximately 1 mm from the surface. The vortex position, as well as the vortex drift angle can be determined through static pressure measurements on the surface downstream of the vortex generator as described above. In this example vortex generator 400 a dielectric layer 404 such as polyimide (e.g., Kapton) is disposed on the pressure side of the vane 402 (employing a trapezoidal shape). A grounded electrode 406 is disposed on the leading edge of the vane 402 on the pressure side. The grounded electrode 406 is encapsulated to form the dielectric barrier from the high voltage electrode 408. The high voltage electrode 408 is also disposed on the pressure side of the vane 402 running adjacent and parallel along the grounded electrode 406 having the dielectric barrier between the two electrodes 406, 408. Both the grounded electrode 406 and the high voltage electrode 408 comprise an electrically conductive material (e.g. copper, or any other suitable electrically conductive material) wrapped around edges of the vane 404, the grounded electrode 406 wrapped around the leading edge of the vane 402 and the high voltage electrode 408 wrapped around the trailing edge of the vane 402. Contacts to the wires 410, 412 are then made on the suction side of the vane 402. It should be noted that the position of the high voltage and grounded electrodes 406, 408 can inverted. In addition, encapsulation of the electrodes can be either or both electrodes 406, 408 to form the proper dielectric barrier between the electrodes 406, 408. Application of the proper RE voltage and power will depend upon the application and requirements to generate sufficient plasma in the air passing near the space between the two electrodes 406, 408 as will be understood by those skilled in the art. Typical applied AC voltages between the electrodes 406, 408 are between 4 kV and 8.5 kV with frequencies around 9 kHz and 500 ns pulses. Other powers and settings are possible depending on the topology of the electrodes 406, 408 and actuators as well as vortex control flow needs.

FIG. 4B is a schematic diagram of an exemplary vortex generator 420 comprising a corona discharge plasma actuator. This alternate type of plasma actuator comprises the same elements as the dielectric barrier discharge plasma actuator for the vortex generator 400 above. However, in this case the high voltage electrode 408 is configured to have a much larger gap with the grounded electrode 406. The electrode 408 has a comb configuration formed by a set of wires running in parallel or forming a linear array. Electrodes 406 and 408 are separated just by air and there is not a dielectric layer between them. Application of the proper DC voltage and power will depend upon the application and requirements to generate sufficient plasma in the air passing near the space between the two electrodes 406, 408 as will be understood by those skilled in the art. The voltage requirements for the corona discharge are significantly greater than that of the dielectric barrier discharge plasma actuators. Applied DC voltages vary between 13 kV and 25 kV depending on the actuator design as well as vortex control flow requirements.

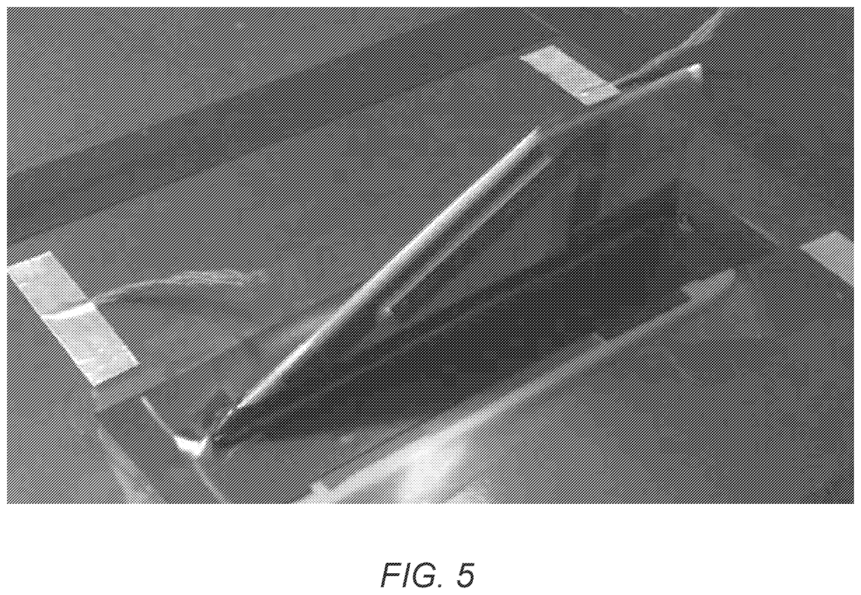

FIG. 5 illustrates an example vortex generator comprising a functional single plasma actuator consistent with the vortex generator 400 of FIG. 4A employing a dielectric barrier discharge. Examining the pressure measurements, a displacement of the vortex by the plasma actuator can be found. The induced flow can yield a reduction of the vortex drift angle. Assessing the ratio between the body force induced by the plasma and the lift of the vortex generator, the positioning of the actuator close to the leading edge of the vortex generator can produce a highly effective means to influence the vortex development.

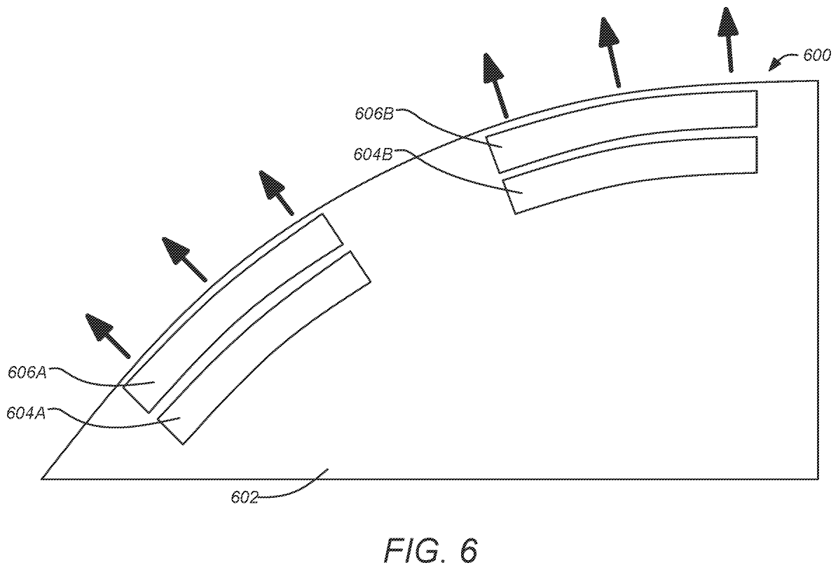

FIG. 6 is a schematic of a vortex generator 600 comprising a plurality of electrical plasma actuators. In this case, separate pairs of a ground electrode 606A, 606B and a powered electrode 604B, 604B are disposed on the vane 602 parallel to one another near the leading edge of the vane 602. Although, this vortex generator 600 shows only two separate plasma actuators, those skilled in the art will appreciate that additional separate plasma actuators can be added under the same principle. The details regarding design and operation of the individual plasma actuators on this vortex generator 600 is the same as either of the vortex generators 400, 420 of FIGS. 4A and 4B. Although the plasma actuators are depicted similar to the dielectric barrier discharge plasma actuators of FIG. 4A, those skilled in the art will appreciate that the separate plasma actuators can alternately be implemented as corona discharge plasma actuators as shown in FIG. 4B.

### 3.0 Exemplary Gas Injector Vortex Generator

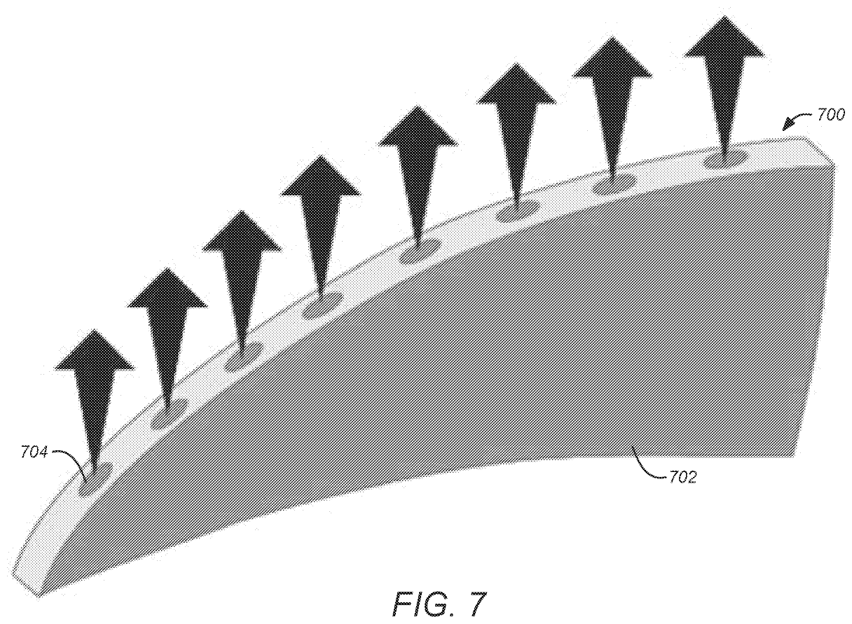

FIG. 7 illustrates an example vortex generator 700 comprising a plurality of air jet injectors on its leading edge. The vortex generator 700 comprises a vane 702 or strake shape having a plurality of ports 704 along its leading edge. Each port 704 is separately operable to deliver or draw gas (e.g. air) to affect the fluid flow passing the vane 702. It is important to note that the ports 704 can be designed to operate by forcing gas out (as indicated by the shown arrows) or drawing gas in (suction) or both. In either case, it is only important to understand how activation of the “jet” (out or in) affects the passing fluid flow. Accordingly, throughout the description reference to a gas “jet” is intended to indicate either forcing gas out or drawing gas in through the port 704 as necessary to affect the vortex position/size based on the particular application. Those skilled in the art will appreciate that any suitable shape for the vane 702 or number of individual ports 704 are possible depending upon a particular application.

### 4.0 Exemplary Positionable Vane Vortex Generator

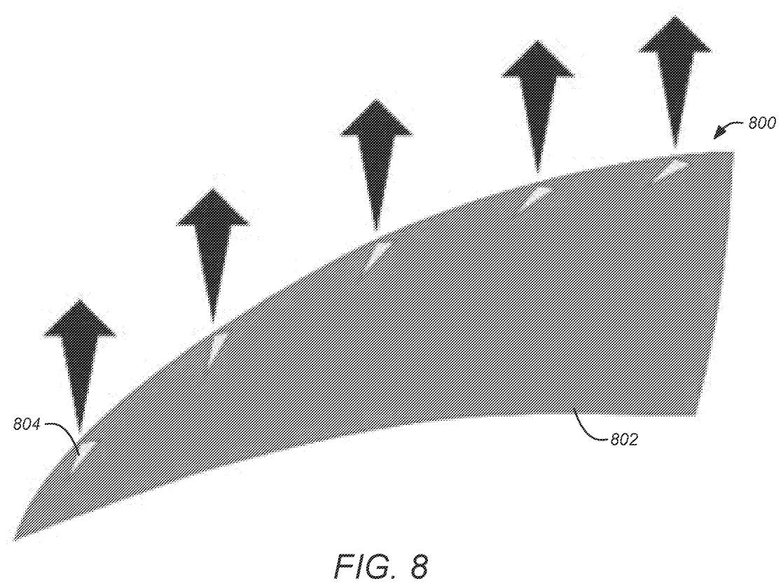

FIG. 8 illustrates another vortex generator 800 comprising multiple positionable vanes 804 on its leading edge. In this case, relatively small discontinuities (e.g. small tab, bump, fin, pin, or any other similar mechanical device) are disposed on a positionable element extending from the surface of the supporting vane 802 leading edge as described hereafter. In one embodiment of the invention, a plurality of smaller vortex generator vanes can be disposed on the leading edge of a larger vortex generator. Such positionable devices and/or actuators can be disposed not only on the supporting vane 802 leading edge but also on its trailing edges, and/or on both sides if needed based on a particular application as will be understood by those skilled in the art. In addition, those skilled in the art will appreciate that any suitable shape for either the supporting vane 802 or number of individual positionable elements 804 are possible depending upon a particular application. The small vanes can be activated collectively or individually using shape-memory-alloy-based actuator such as Nitinol (Nickel-Titanium), piezo electric actuators, micro-electro-machine actuators (MIDAS), and small servomechanisms among others. For example, a piezoelectric element can be used to change the angle of attack of the tiny vane when activated by an electrical current that flows over a printed electronics circuit deposited on the strake or large vortex generator. Other actuator mechanisms or design configurations are also possible.

### 5.0 Exemplary Active Vortex Generator System

In one example embodiment of the invention, air injection can be used to produce the force on the passing fluid flow based on the general description of the vortex generator 700 of FIG. 7 above. In one example, vortex generators can be designed with different nozzle shapes, for example, a round outlet or a rectangular shape. In any case, a plurality of outlet positions can be used. Those skilled in the art will appreciate that any other suitable shape and/or number of ports are possible depending upon the particular application.

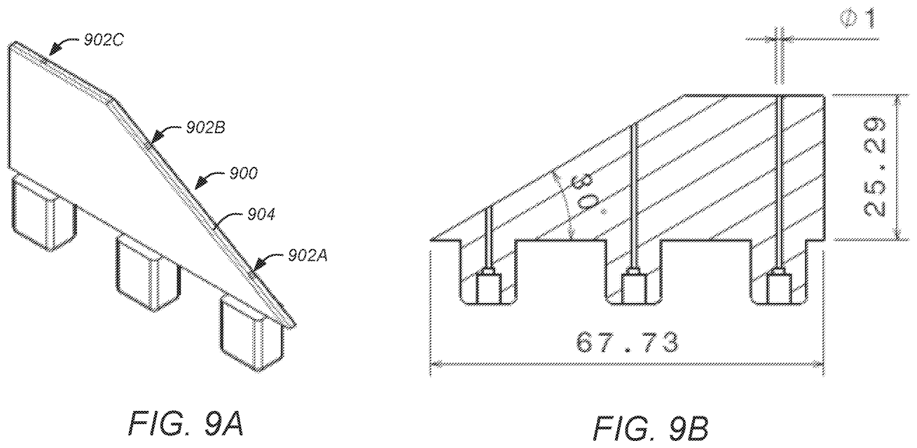

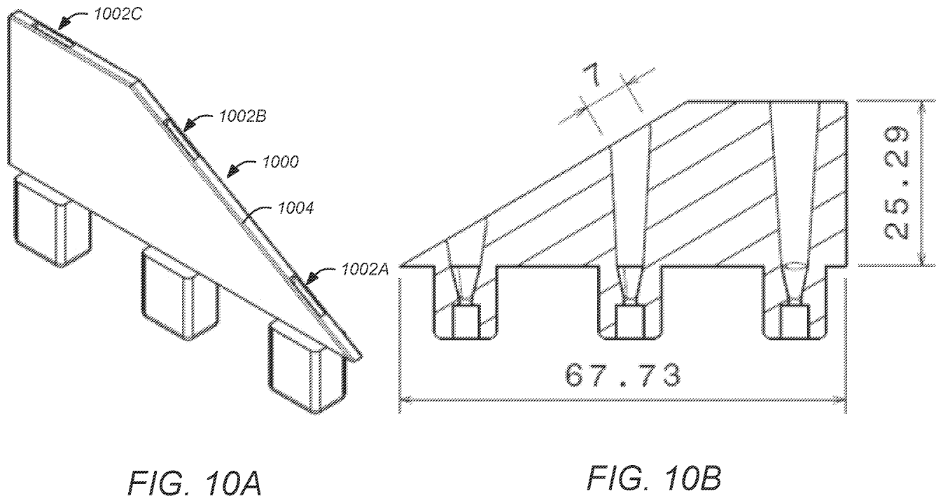

FIGS. 9A and 9B illustrate a vortex generator 900 comprising multiple air jet injectors 902A, 902B, 902C on its leading edge each having a circular outlet. FIGS. 10A and 10B illustrates a vortex generator 1000 comprising multiple air jet injectors 1002A, 1002B, 1002C on its leading edge each having a slotted outlet. Although particular dimensions for the ports and vanes are shown in FIGS. 9B and 10B, it should be noted that these dimensions were only applicable to models for study; port shape, number and dimensions of the ports and vane can be varied based on the particular application.

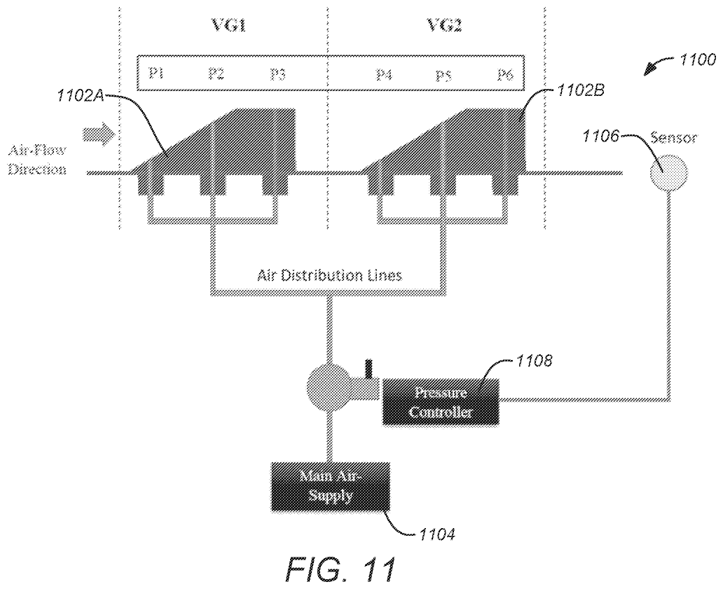

FIG. 11 is a schematic diagram of an example system 1100 employing a plurality of vortex generators 1102A, 1102B each comprising multiple air jets, P1, P2, P3 in one vortex generator 1102A and P4, P5, P6 in another vortex generator 1102B. All the air jets P1, P2, P3, P4, P5, P6 are driven by an air supply 1104 under control by a sensor 1106. The air jets P1, P2, P3, P4, P5, P6 are separately activated through a pressure controller 1108 which activates each air jet P1, P2, P3, P4, P5, P6 based on input from the sensor 1106. Note although the air distribution lines are depicted being coupled together after the pressure controller 1108, separate lines (or valves) to each air jet. P1, P2, P3, P4, P5, P6 are used by the pressure controller 1108 to separately activate each jet P1, P2; P3, P4, P5, P6 as needed based on the sensor 1106 information. Sensor type can vary as described in examples hereafter.

Depending on the application, one or more such vortex generators 1102A, 1102B can be controlled (i.e. have installed actuators or injectors). The hollow vortex generators 1102A, 1102B can be manufactured using conventional subtracting manufacturing (e.g. drilling, mining, casting, electro-machining), additive manufacturing (e.g. metal, composite, or polymer 3D printing) methods, injection molding, resin transfer, powder methods and/or casting techniques among others. Vortex generators 1102A, 1102B could be alternately employed using plasma actuators or positionable elements as previously described. Electrical actuators (e.g. plasma actuators) can be embedded, bonded, and/or deposited using printed electronic techniques or other additive manufacturing processes.

To visualize the effects of the air injection and to determine the exact position of the vortex, a setup was designed and built that allowed the measurement of velocity fields downstream of the vortex generator. These measurements were performed in a small wind tunnel with the vortex generator mounted on a flat wall. Multiple tests were performed with variation of the injection pressure and position (i.e. ports). The vortex generator was mounted at an angle of attack of 20°, supply pressure to the nozzles was regulated to values between 10 and 40 psi. Other pressures and/or angles of attack are possible.

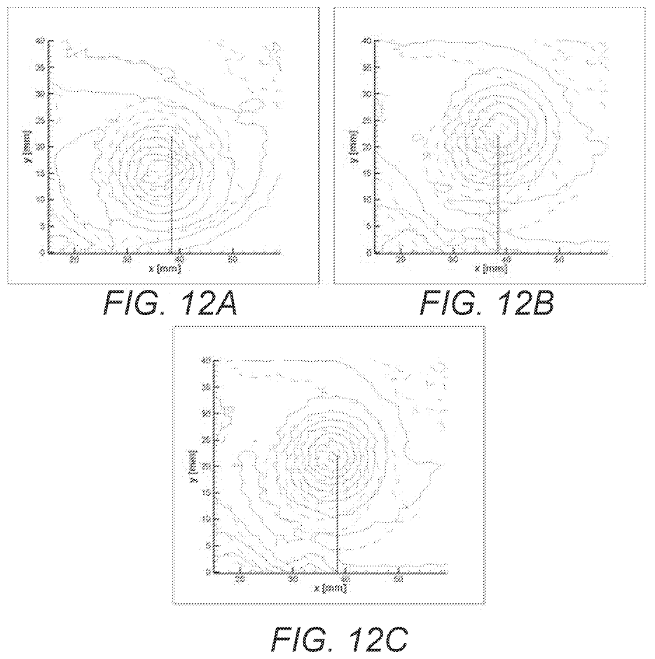

FIGS. 12A to 12C are example fluid flow velocity measurement plots downstream from a vortex generator using round ports (e.g. as shown in FIGS. 9A and 9B) at 15 psi. Each plot represents the result of activating only one of the ports in the vortex generator 900, FIG. 9A is port 902A, FIG. 9B is port 902B, and FIG. 9C is port 902C. Baseline data for a passive vortex, i.e. no activation, is plotted using dash lines. Data for the active or moved vortex is plotted with solid lines. The vortex (shape and localization) can be clearly identified in the figures due to the reduced dynamic pressure that can be measured by means of a pitot tube pointed against the main flow direction. The solid vertical line indicates the position of the vortex generator's trailing edge, upstream of the position of the pitot tube.

The results show that injection at one or multiple positions on a vortex generator can move the position of the vortex core, both in vertical and horizontal direction. Especially, noteworthy is the fact that an injection at the position closest to the forward tip of the vortex generator (Position 1) can lead to a vertical displacement of the vortex moving it closer to the wall, counter-intuitively to what would be expected when introducing a force away from the wall (see e.g. FIG. 12A). However, injection at Position 2 as well as at Position 3 move the vortex in the opposite direction, further away from the wall as expected.

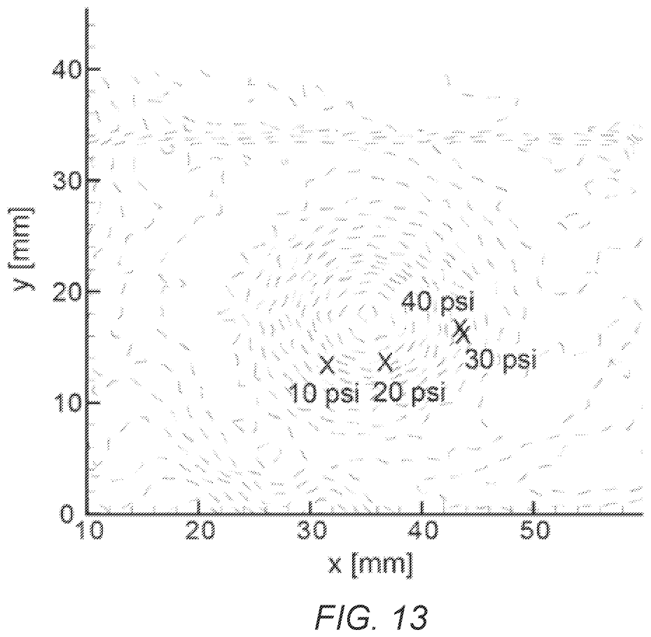

FIG. 13 shows an example position change of the vortex center from varying injection pressure at position 1 relative to the baseline case without injection. This shows the influence of the injection pressure on the vortex position. While the magnitude of displacement stays roughly the same, the vortex core is moved further to the left at a lower injection pressure while moving to the right with increasing pressure.

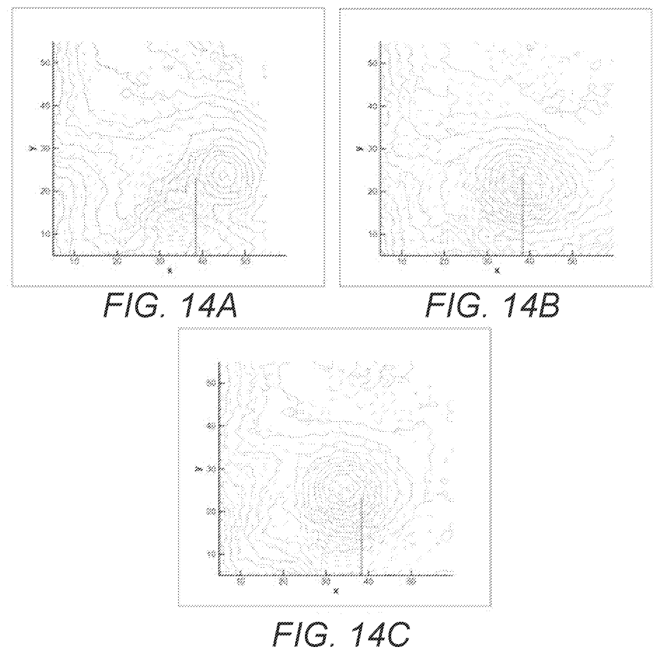

FIGS. 14A to 14C are example fluid flow velocity measurement plots downstream from a vortex generator using slotted ports (e.g. as shown in FIGS. 10A and 10B) at 10 psi. Each plot represents the result of activating only one of the ports in the vortex generator 1000, FIG. 10A is port 1002A, FIG. 10B is port 1002B, and FIG. 10C is port 1002C. These plots show the velocity fields behind the vortex generator, when the formation of the vortex is manipulated by injection of pressurized air through rectangular slots. As indicated, the vortex can be displaced in both horizontal and vertical direction through selective operation of the jets through the ports.

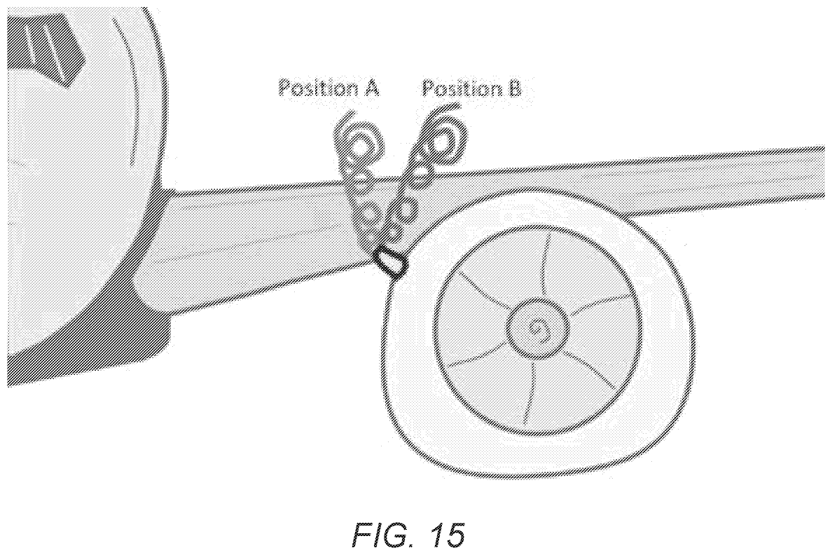

One application for embodiments of the invention is the use on aircraft engine nacelle strakes (vanes or chines), which are essentially large vortex generators. Such strikes are common on existing aircraft, useful to inhibit boundary layer separation during low-speed flight, such as take-off and landing, particularly with flaps deployed. The vortex from a nacelle strake flows over the upper surface of the wing, pumping high-momentum fluid towards the surface to inhibit separation. Using leading edge injection to control the vortex produced by the strake can lead to significantly increased effectiveness of these devices. Thus, the present invention allows the position of the vortex to be controlled for different flight conditions for optimum performance. FIG. 15 illustrates an example of such vortex flow control over an aircraft engine nacelle where the vortex is moved from position A to position B under activation of any of the active vortex generator types previously described. Using the air jet system for vortex control, available bleed air from the nearby engine compressor can be employed to be injected through one or more nozzles along the swept leading edge of the strake to optimize the position and strength of the vortex. This represents an efficient adaptation of an available pressurized air supply.

As described, a vortex can be displaced (or moved) and its circulation can be changed by pneumatic (air injection), small fins/VGs, and/or plasma actuators among other type of actuators mounted on the leading edge of a chine. These actuators generate a force at the leading edge of the chine, where the flow is most sensitive. As a result, the vortex can inhibit separation over the wing and thereby increase aircraft/wing, maximum lift coefficient (C_{L,max}). In this case, the system can reduce noise footprint during takeoff and landing by increasing C_{L,max}. As a result, the needed runway distance can be reduced. Furthermore, the high-lift system (e.g. flaps and slats) can be simplified, thereby reducing the vehicle/structure weight and the complexity (i.e. using less parts and/or smaller areas).

### 6.0 Exemplary Active Vortex Generator System on a Wing or Fuselage

In a further embodiments of the invention, a system can use one or multiple sensors (e.g. pressure sensors, heat flux sensors, optical sensors) that can determine the present state and position of the vortex, and selectively activate the vortex generator elements, establishing a control loop. Such sensors can be disposed in front of the vortex generator (upstream) and/or behind the vortex generator (downstream). Selective activation of the actuator (e.g. injection of air, plasma, or positionable elements) can then operate to manipulate the position of the vortex very precisely to efficiently achieve the desired effect. It should be noted that additional vortex generators of any type described herein can be positioned with any vortex generator in a series configuration to enhance and/or to amplify the control effect.

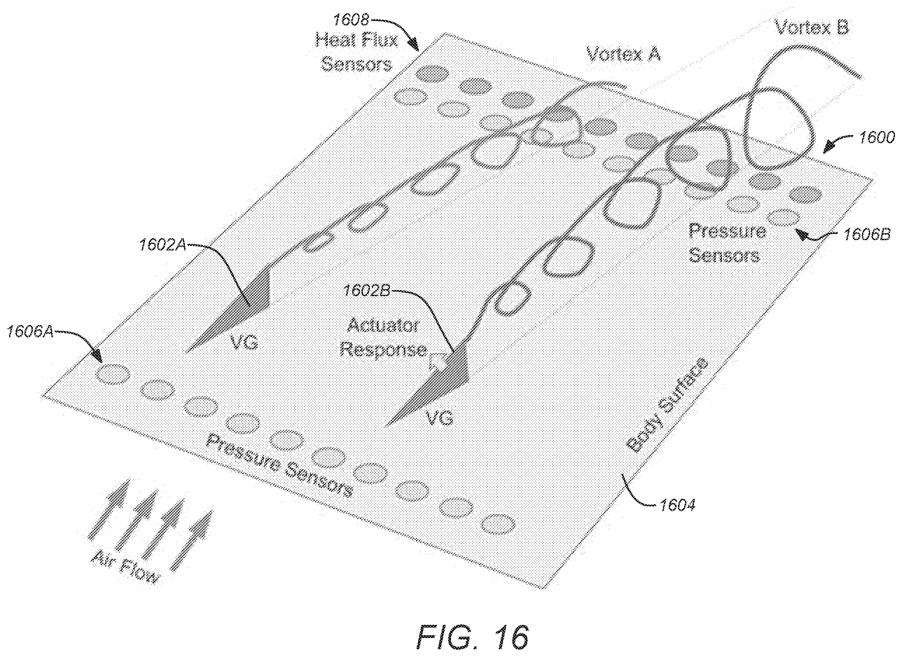

FIG. 16 illustrates an example sensing layout for a vortex control system 1600 where vortex B from vortex generator 1602B represents a modified vortex A from vortex generator 1602A that has been controlled/modified by an actuator mounted on vortex generator 1602B. In this system 1600, the vortex generators 1602A, 1602B are in disposed in parallel on a body surface 1604 (e.g. aircraft wing or fuselage). An array of pressure sensors 1606A can be disposed in the body surface 1604 upstream from the vortex generators 1602A, 1602B in the air flow. Another array of pressure sensors 1606B can disposed in the body surface 1604 downstream from the vortex generators 1602A, 1602B in the air flow. Differential pressure can be determined across these pressure sensors 1606A, 1606B. Another array of heat flux sensors 1608 can also be disposed in the body surface 1604 downstream from the vortex generators 1602A, 1602B in the air flow.

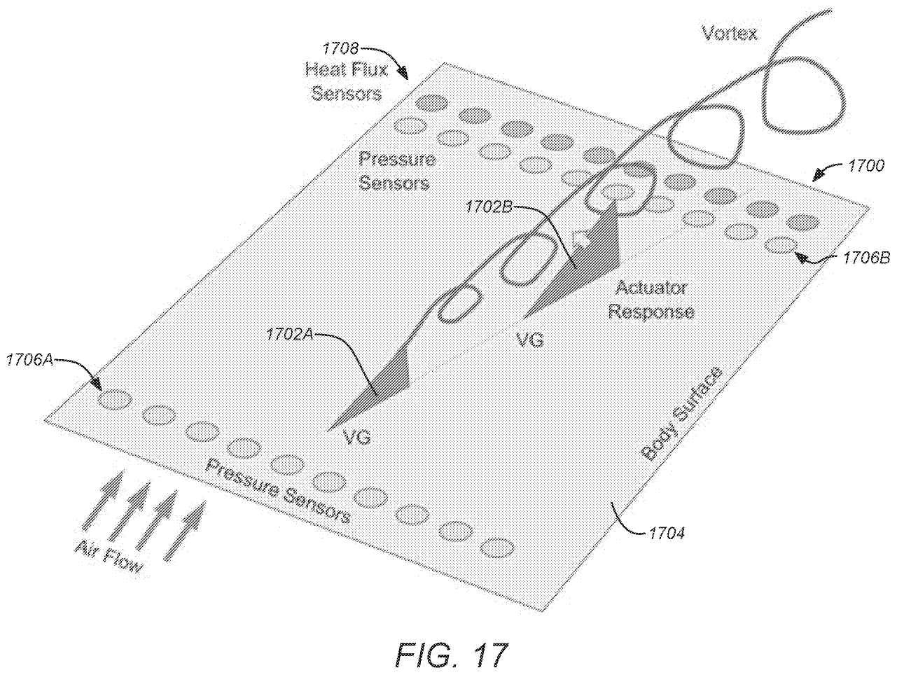

FIG. 17 illustrates another example sensing layout for a vortex control system 1700 where the vortex has been controlled and/or modified by an actuator mounted on a vortex generator. In this case, the vortex generators 1702A, 1702B are in disposed in series on a body surface 1704 (e.g. aircraft wing or fuselage). Similar to FIG. 16 above, an array of pressure sensors 1706A can be disposed in the body surface 1704 upstream from the vortex generators 1702A, 1702B in the air flow. Another array of pressure sensors 1706B can disposed in the body surface 1704 downstream from the vortex generators 1702A, 1702B in the air flow. Differential pressure can be determined across these pressure sensors 1706A, 1606B. Another array of heat flux sensors 1708 can also be disposed in the body surface 1704 downstream from the vortex generators 1702A, 1702B in the air flow.

In a further example embodiment of the invention, optical sensors can also be mounted in such a way that can observe and/or monitor the region of interest with a given view angle (0° to 180°). Such optical sensors can be mounted on any suitable fuselage window or panel pointing towards an area of the wing or fuselage, e.g. as shown in FIG. 16 or 17. In another configuration, the sensors can be placed on the same surface (i.e. wing or fuselage) looking up or to an angle behind the sensor, e.g. as shown by position of any of the pressure or heat flux sensors 1606A, 1606B, 1608, 1706A, 1706B, 1708. Such optical sensors can be mounted on any aerodynamic fairing or pod on internal or external flows.

As described, a controllable vortex using an embodiment of the invention can be used as part of an active vortex control system over a wing surface to re-laminarize a turbulent boundary layer. This can lower total aircraft drag, potentially by as much as a factor of two. Such lower drag corresponds to yielding advantages of lower fuel consumption, CO₂ emissions, lower electrical power consumption, and lower noise.

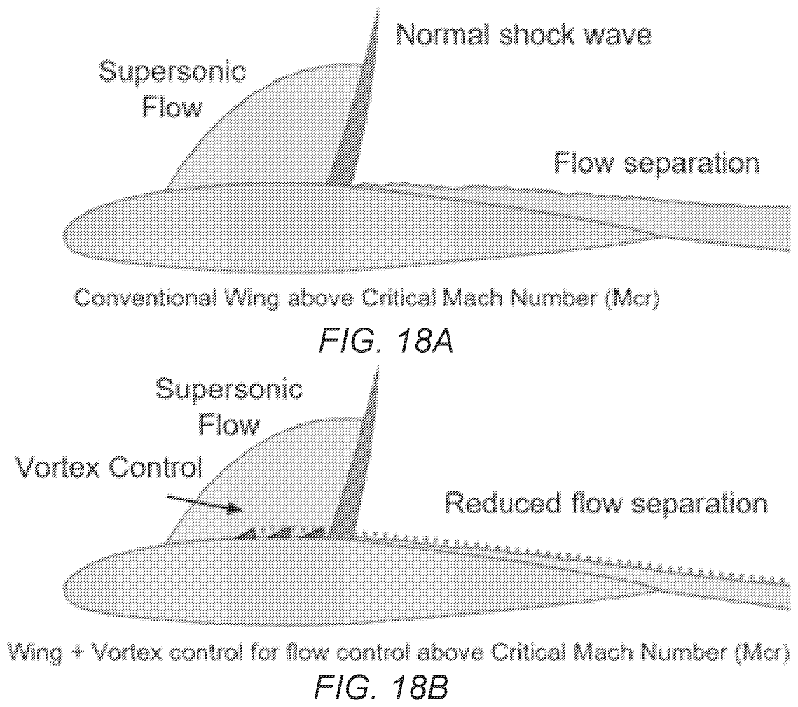

Employing embodiments of the invention, the use of vortex control can be applied to reduce flow separation at transonic flow speed. FIG. 18A illustrates flow separation for an example conventional wing above the critical Mach number without vortex control. In contrast FIG. 18B illustrates flow separation for an example conventional wing above the critical Mach number with vortex control. This can also be applied on aircraft fuselages to reduce flow separation at transonic flow speeds.

In addition, the ability to move a vortex and/or sheet of vortices close to a wall or away from it employing embodiments of the invention provides a way to control heat fluxes through and/or around the wall or surface. A vortex closer to a wall enhances convective heat transfer by transporting heat through the boundary layer. This application can be important for high speed flows or high temperature flows (T∞) where a substrate surface (e.g. wing, fuselage, motor blade, nose, radome, motor case, nozzle, injector, rocket engine) must be kept at a given temperature T_{w} (max operational temperature) that is below its melting point. It is clear that the vortex control system embodiments of the present invention can increase durability of such structures and/or improve their performance. Such walls or substrates can be used for internal flows and/or external flows applications.

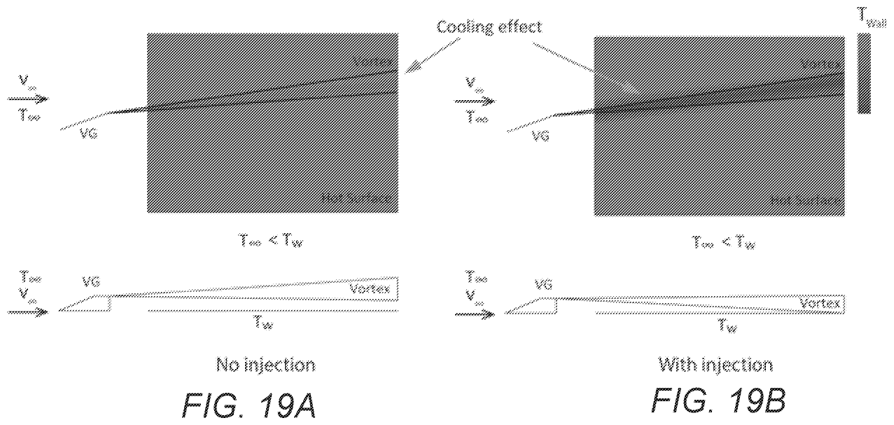

In further embodiments of the invention, a vortex control system according to the described principles can be used to increase heat fluxes to cool down a hot surface (T_{w}). FIGS. 19A and 19B illustrate this concept showing flow over a hot surface with vortex generators without and then with injection.

In yet further embodiments of the invention, the use of such vortex control can also be applied to enhance or reduce mixing on fluids single specie or multiple species (e.g. chemical reactions, combustion, evaporation) as will be understood by those skilled in the art.

Those skilled in the art will appreciate that the invention illustrated by the various described embodiments herein has application not only on aerial vehicles (aircraft, rotorcraft, drones, engines) and wind turbine systems but also on power plant engines, chemical reactors, rocket engines, underwater vehicles (e.g. submarines) and other underwater devices and structures (e.g. turbines, dams, doors, etc.) where vortices may be present. More broadly, embodiments of the invention can be used anytime a vortex from a vortex generator needs to be controlled.

The foregoing description, including the preferred embodiments of the invention, has been presented for the purposes of illustration and description. It is not intended to be exhaustive or to limit the invention to the precise form disclosed. Many modifications and variations are possible in light of the above teaching. The above specification provides a complete description of the apparatus, method and use of the invention.

What is claimed is:

1. A system for controlling fluid flow comprising:
a surface for being influenced by a fluid flow moving across the surface;
a vortex generator comprising a strake disposed forward in the fluid flow from the surface, the vortex generator for altering a vortex pattern within the fluid flow moving across the surface by exerting a force at a leading edge of the stroke when activated; and
a controller for activating the vortex generator to alter the vortex pattern within the fluid flow moving across the surface.

2. The system of claim 1, wherein altering the vortex pattern comprises repositioning the fluid flow and the vortex to re-laminarize a turbulent boundary layer passing the surface.

3. The system of claim 1, further comprising a sensor for sensing an undesirable vortex pattern and triggering the controller to activate the vortex generator.

4. The system of claim 1, wherein the force is generated by a plasma actuator generating a plasma within the fluid flow.

5. The system of claim 4, wherein the plasma actuator comprises a dielectric barrier discharge (DBD) plasma actuator.

6. The system of claim 4, wherein the plasma actuator comprises a corona discharge plasma actuator.

7. The system of claim 1, wherein the vortex generator comprises one or more actuated vanes disposed along the leading edge of the strake each positionable at a varied pitch against the fluid flow to exert the force.

8. The system of claim 1, wherein the vortex generator comprises one or more fluid injectors disposed along the leading edge of the strake each for injecting a fluid jet into the fluid flow to exert the force.

9. The system of claim 8, wherein each fluid jet of the one or more fluid injectors is driven by gas pressure.

10. The system of claim 8, wherein at least one fluid jet of the one or more fluid injectors is injected from a cylindrical port.

11. The system of claim 8, wherein at least one fluid jet of the one or more fluid injectors is injected from a rectangular port.

12. The system of claim 8, wherein the one or more fluid injectors are each operated independently by the controller to improve different undesirable vortex patterns within the fluid flow.

13. The system of claim 1, wherein the strake is disposed on an engine nacelle and the surface comprises a wing surface.

14. The system of claim 1, further comprising one or more sensors for sensing the vortex pattern within the fluid flow as undesirable and triggering the controller to activate the vortex generator to improve the vortex pattern within the fluid flow, wherein the surface comprises at least a portion of a wing or fuselage surface and the strake is disposed thereon.

15. The system of claim 14, wherein the one or more sensors comprise one or more heat flux sensors embedded in the wing or fuselage surface for sensing the vortex pattern as undesirable within the fluid flow.

16. The system of claim 14, wherein the one or more sensors comprise one or more pressure sensors embedded in the wing or fuselage surface for sensing the vortex pattern as undesirable within the fluid flow.

17. The system of claim 1, wherein the surface is on an aerial or land vehicle and the fluid flow comprises air.

18. The system of claim 1, wherein the surface is on an underwater vehicle and the fluid flow comprises water.

19. A method for controlling fluid flow comprising:
creating a surface for being influenced by a fluid flow moving across the surface;
disposing a vortex generator comprising a strake forward in the fluid flow from the surface, the vortex generator for altering a vortex pattern within the fluid flow moving across the surface by exerting a force at a leading edge of the strake when activated; and
activating the vortex generator with a controller to alter the vortex pattern within the fluid flow moving across the surface.

20. An apparatus for controlling fluid flow comprising:
a surface for being influenced by a fluid flow moving across the surface;
a vortex generator comprising a strake disposed forward from the surface in the fluid flow and comprising one or more fluid injectors disposed on a leading edge of the strake each for injecting a fluid jet into the fluid flow driven by air pressure, the vortex generator for altering a vortex pattern within the fluid flow moving across the surface by exerting a force at the leading edge of the strake; and
a controller for activating the vortex generator to alter the vortex pattern within the fluid flow moving across the surface.

21. The apparatus of claim 20, further comprising one or more sensors for sensing an undesirable vortex pattern and triggering the controller to activate the vortex generator to improve the undesirable vortex pattern within the fluid flow.
